(19) United States
(12) Patent Application Publication
(10) Pub. No.: US 2008/0059586 A1
(43) Pub. Date: Mar. 6, 2008

(54) METHOD AND APPARATUS FOR ELIMINATING UNWANTED E-MAIL

(76) Inventors: Susann Marie Keohane, Austin, TX (US); Gerald Francis McBrearty, Austin, TX (US); Shawn Patrick Mullen, Buda, TX (US); Jessica Kelley Murillo, Round Rock, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(21) Appl. No.: 11/465,513

(22) Filed: Aug. 18, 2006

(51) Int. Cl. G06F 15/16

(52) U.S. Cl. 709/206

(57) ABSTRACT

A computer implemented method, apparatus and computer usable program code for processing e-mail messages. In response to a selection of a particular e-mail message from a sender as being undesired, a message identifier is stored in the e-mail message, wherein the message identifier uniquely identifies the e-mail message and any subsequent replies based on the e-mail message. Further, in response to receiving another e-mail message, the another e-mail message is processed using a policy to filter out e-mail messages containing the message identifier, wherein subsequent e-mail messages from the sender without the message identifier are unfiltered.

### BACKGROUND OF THE INVENTION

1. Field of the Invention

The present invention relates generally to an improved data processing system and in particular to a method and apparatus for processing messages. Still more particularly, the present invention relates to a computer implemented method, apparatus, and computer usable program code for eliminating unwanted e-mail messages.

2. Description of the Related Art

Electronic mail involves composing, sending, storing, and receiving messages over a network, such as the Internet. Electronic mail is also referred to as e-mail. E-mail has become a common form of communication for many people. E-mail is used for both personal and business purposes. Businesses often rely on e-mail messages to quickly send information. Oftentimes, the information may be sent in the form of attachments to e-mail. Users may access e-mail though dedicated e-mail application, such as Lotus Notes or Microsoft Outlook. Lotus Notes is a product available from International Business Machines Corporation, and Microsoft Outlook is a product available from Microsoft Corporation. Users also may access e-mail through web based interfaces using a program, such as a browser.

With the growing popularity of e-mail for both business and personal use, users are often receiving messages they do not want to read or have no interest in reading. Users are often subjected to unsolicited e-mail messages that are commercial in nature. This type of unwanted commercial e-mail also is referred to as spam. Spam filters have improved greatly. Unsolicited e-mail, however, is still a large problem for many users. People who send unwanted commercial e-mail can send hundreds of millions of e-mail messages each day over an inexpensive Internet connection. With a large number of people and businesses sending unwanted e-mail, information overload occurs for many users. Some users may receive tens or even hundreds of unwanted messages each day.

A user is required to look through the e-mail and delete unwanted e-mail messages. This procedure can be time consuming and frustrating. A number of mechanisms have been implemented to eliminate unwanted e-mail messages. One example is using spam filters on services for providing for e-mail as well as on e-mail applications.

### SUMMARY OF THE INVENTION

The present invention provides a computer implemented method, apparatus, and computer usable program code for processing e-mail messages. In response to a selection of a particular e-mail message from a sender as being undesired, a message identifier is stored in the e-mail message. The message identifier uniquely identifies the e-mail message and any subsequent replies based on the e-mail message. Further, in response to receiving another e-mail message, the another e-mail message is processed using a policy to filter out e-mail messages containing the message identifier, wherein subsequent e-mail messages from the sender without the message identifier are unfiltered.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a diagram illustrating components used in processing e-mail messages in accordance with an illustrative embodiment;

FIG. 4 is a diagram illustrating an e-mail client in accordance with an illustrative embodiment;

FIG. 5 is a diagram illustrating an e-mail message in accordance with an illustrative embodiment;

FIG. 6 is a diagram illustrating a graphical user interface for managing e-mail messages in accordance with an illustrative embodiment;

FIG. 7 is a flowchart of a process for selecting e-mail message as being uninteresting in accordance with an illustrative embodiment; and

FIG. 8 is a flowchart of a process for processing an e-mail message in accordance with an illustrative embodiment.

### DETAILED DESCRIPTION OF THE PREFERRED EMBODIMENT

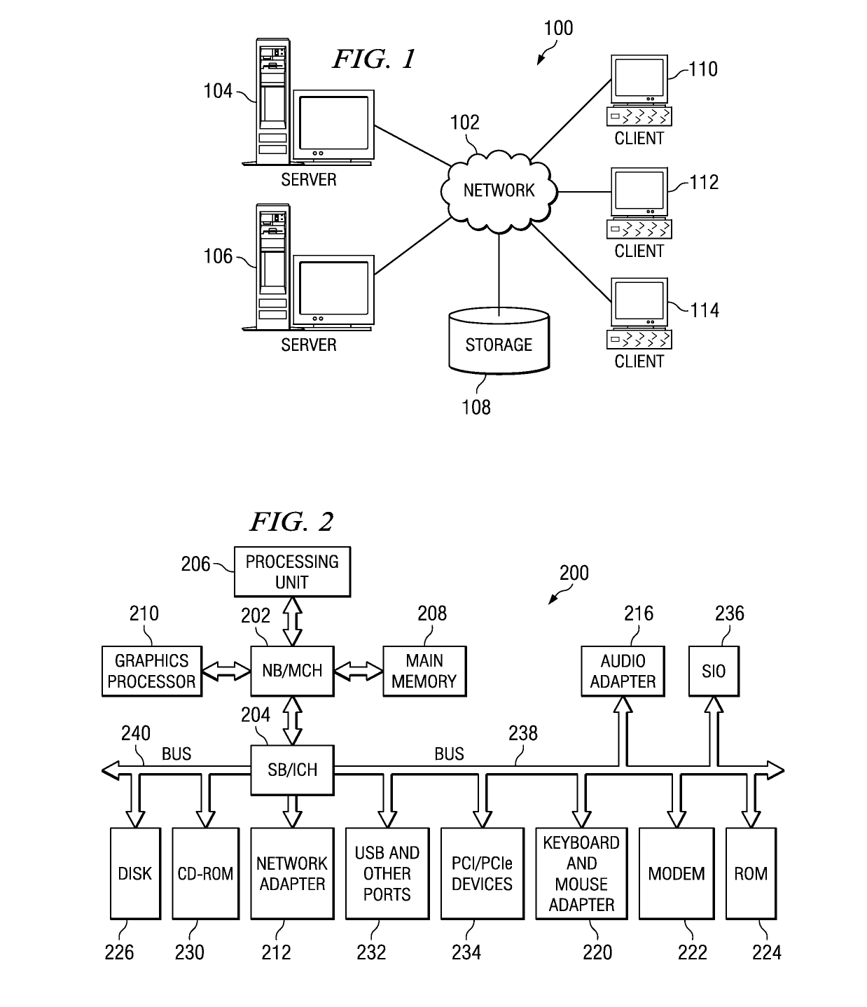

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and compute usable program code for processing e-mail messages. In response to a selection of an e-mail message from a sender as being undesired, a message identifier in the e-mail message is located and stored. This message identifier uniquely identifies the e-mail message and any subsequent replies based on the e-mail message. For example, subsequent replies in which the recipient may be carbon copied (CCd) also include this particular identifier. Typically, this identifier is a message ID that is encoded in the e-mail header. Of course, the identifier could take other forms depending on the particular implementation.

When other e-mail messages are received, these messages are processed to determine whether they contain the message identifier. If the subsequent messages contain the identifier, these messages are filtered out or processed. By filtering out these e-mail messages, the messages may be placed in another location other than the typical location for incoming e-mail messages. For example, these undesired e-mail messages in a trash bin, a deleted folder, or a spam folder as examples. Other e-mail messages from the sender without the message identifier remain unfiltered and reach the recipient in these illustrative embodiments. As a result, when a user sees e-mail messages and desires that the user is no longer interested in that message or the topic of that message, other replies that are carbon copies to the user are automatically filtered out in the illustrative embodiments.

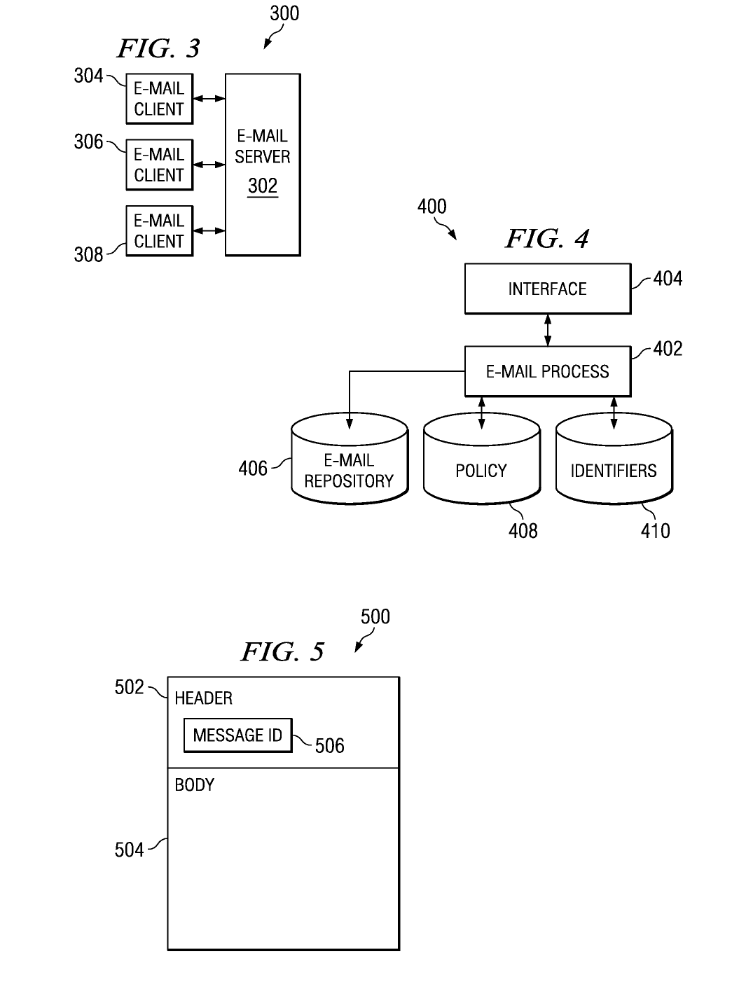

Turning now to FIG. 3, a diagram illustrating components used in processing e-mail messages is depicted in accordance with an illustrative embodiment. In these examples, the different processes and components of the present invention may be implemented in e-mail system 300. E-mail system 300 contains e-mail server 302, e-mail client 304, e-mail client 306, and e-mail client 308.

E-mail server 302 is a server process that may run on a computer, such as server 104 or 106 in FIG. 1. E-mail server 302 is a typical e-mail server process provided by different organizations to provide e-mail service to users. E-mail server 302 receives messages and distributes them to other e-mail servers or clients.

E-mail clients 304, 306, and 308 are software processes that may run on client computers such as client 110 or 112 in FIG. 1. E-mail clients 304, 306, and 308, may take various forms. For example, these clients may be e-mail applications, such as Microsoft Outlook or Lotus Notes. Lotus Notes is a product available from International Business Machines Corporation, and Microsoft Outlook is a product available from Microsoft Corporation. Additionally, these clients also may take the form of a web based client in which the e-mail is accessed through a browser program.

E-mail server 302 typically sends messages using simple mail transfer protocol (SMTP), which is a protocol for transmission of e-mail messages across the Internet. E-mail clients 304, 306, and 308 may retrieve e-mail messages from e-mail server 302 using protocols, such as post office protocol version 3 (POP3) or Internet message access protocol (IMAP).

In the illustrative embodiments, the selection of e-mail messages as being no longer interesting or undesired are implemented in processes located on e-mail clients. Depending on the particular implementation, the processes may be implemented on e-mail server 302. For example, with a web based e-mail access system, these processes are location of e-mail server 302 rather than on one of the clients.

Turning now to FIG. 4, a diagram illustrating an e-mail client is depicted in accordance with an illustrative embodiment. As illustrated, e-mail client 400 is a more detailed example of an e-mail client, such as e-mail client 304 in FIG. 3.

In this example, e-mail process 402 receives messages from an e-mail server and processes those messages for display to a user on display 404. As depicted, interface 404 is a graphical user interface (GUI) presented to the user to view, manipulate, and create e-mail messages.

E-mail repository 406 serves as a location in which e-mail messages are stored. The e-mail messages located in e-mail repository 406 may be grouped into different folders depending on user preferences. Typically, e-mail repository 406 contains an inbox, a sent folder, and a trash bin. Of course, other folders may be created by the user to store e-mail messages received through e-mail process 402.

In these examples, policy 408 contains rules used to process e-mail messages when they are received by e-mail process 402. When an e-mail message is received by e-mail process 402, e-mail process 402 determines whether a rule is present in policy 408. If one or more rules are present in policy 408, e-mail process 402 determines whether any of these rules apply to the received e-mail message.

These rules may take various forms. For example, a rule may be present in policy 408 that any message from a particular sender is stored in a selected folder rather than the inbox. Another rule may define spam and any e-mail meeting this rule is placed in this folder or a trash bin.

In these illustrative embodiments, policy 408 includes a rule to determine whether the received e-mail messages are undesired or uninteresting e-mail messages. In the depicted examples, the user may designate a received e-mail message presented on interface 404 as being undesired or uninteresting.

Based on this selection, a unique identifier is located in the e-mail message and stored in identifiers 410. In these examples, this unique identifier is a message identifier found in the header of the e-mail message. Of course, other types of identifiers may be used other than a message identifier. For example, the unique identifier may be generated from a combination of the from field, subject field, and a time stamp of when the e-mail message was created.

When subsequent e-mail messages are received, if that message identifier is present in identifiers 410, e-mail process 402 places that message in a folder other than the inbox. For example, the e-mail message could be place in a trash bin or spam folder. In this manner, a user may indicate that a particular message is undesired or uninteresting.

As a result, any replies to that message that are directed towards the user are discarded or handled in a manner designated by the user. Thus, when other users reply and carbon copy this particular user, those messages are not presented to the user in the inbox. However, messages from the original sender continue to reach the user because the handling of these e-mail messages are not based on the actual e-mail addresses or domain names for the e-mail addresses as typically used by currently available spam filters.

Turning now to FIG. 5, a diagram illustrating an e-mail message is depicted in accordance with an illustrative embodiment. E-mail message 500 is an example of an e-mail message that may be received and processed by e-mail client 400 in FIG. 4. In this example, e-mail message 500 includes header 502 and body 504.

The contents of header 502 are defined by various standards for transmitting e-mail messages. Body 504 contains the text entered by the user for the e-mail message. Body 504 may also include graphics or links depending on the particular implementation. Typically, header 502 includes transmission information and recipient information. The transmission information includes, for example, the identifiers for the recipients and sender of the e-mail message. The recipient information may include, for example, the timestamp, reply address, and a subject line. In particular, the recipient information includes message identifier 506.

In these illustrative embodiments, this message identifier is a unique identifier that is present in the e-mail message sent by the sender. Any replies or forwarding of e-mail message 500 also includes message identifier 506.

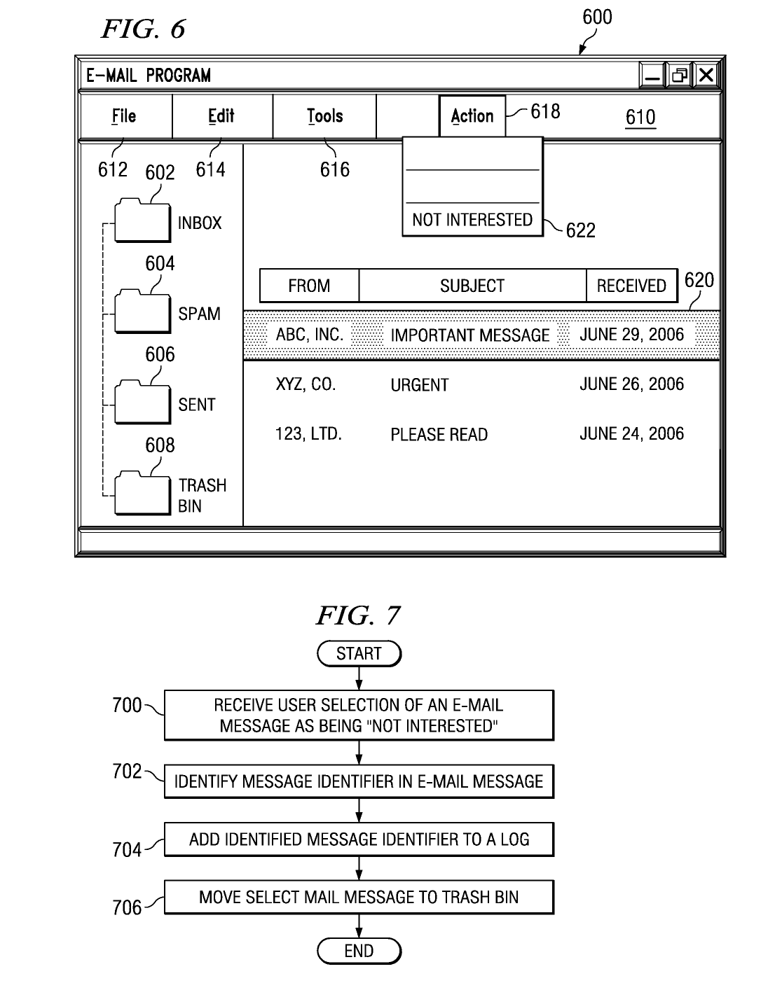

Turning now to FIG. 6, a diagram illustrating a graphical user interface for managing e-mail messages is depicted in accordance with an illustrative embodiment. In this example, graphical user interface 600 is an example of an interface, such as interface 404 in FIG. 4.

As can be seen, graphical user interface 600 includes folders for managing e-mail messages. In these examples, the folders are inbox 602, spam 604, sent 606, and trash bin 608.

Graphical user interface 600 allows for different manipulations of e-mail and the creation of e-mail messages through menu bar 610. In this example, menu bar 610 includes various pull down menus, such as file 612, edit 614, tools 616 and action 618. In this example, the user has selected e-mail message 620, which is present in inbox 602.

The user also has selected not interested entry

622 in action 618. By selecting this entry, e-mail message 620 is identified as an e-mail message that the user is no longer interested in viewing replies. As a result, a message identifier in the e-mail message 620 is located and stored.

Any subsequent messages received by the e-mail client are processed to determine whether those messages contain this message identifier. If the message identifier is present, that e-mail message containing the message identifier is placed into another folder, such as spam 604 or trash bin 608. In this manner, the user no longer has to see any message on this related thread if and when the other users reply to the e-mail message and include the user in a carbon copy (CC). This feature reduces the amount of e-mail messages in inbox 602.

Turning now to FIG. 7, a flowchart of a process for selecting e-mail message as being uninteresting is depicted in accordance with an illustrative embodiment. The steps in FIG. 7 are implemented in an e-mail client, such as client 400 in FIG. 4 through interface 404.

The process begins by receiving a user selection of an e-mail message as being “not interested” (step 700). An example of an interface used to receive the user selection is graphical user interface 600 in FIG. 6. The process then identifies the message identifier in the e-mail message (step 702). The process adds the identified message identifier to a log (step 704). In this example, the log is located in identifiers 410 in FIG. 4. The identifier may be stored in any data structure for later use. For example, the data structure could be a table or linked list instead of a log.

Finally, the process moves the selected mail message to the trash bin (step 706). In these examples, the e-mail message is moved to a trash bin. The e-mail message may be moved to some other folder or even erased from storage, rather than going to a trash bin.

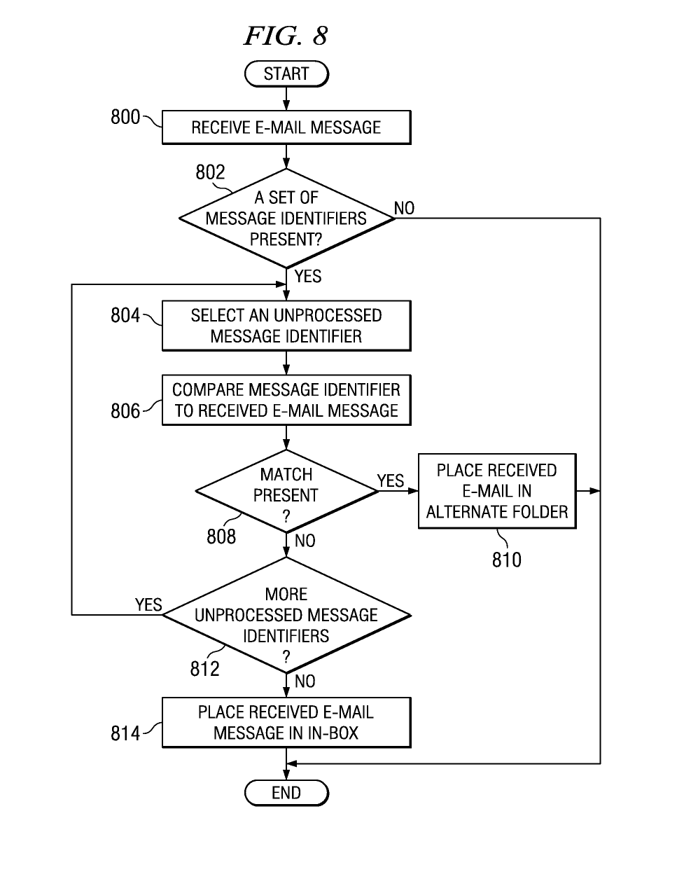

Turning now to FIG. 8, a flowchart of a process for processing an e-mail message is depicted in accordance with an illustrative embodiment. The process in FIG. 8 is implemented in a software component, such as e-mail process 402 in FIG. 4.

The process beings by receiving an e-mail message (step 800). The process then determines whether a set of message identifiers is present (step 802). The set of message identifiers is a set of one or more message identifiers that have been previously stored in response to a user input selecting e-mail messages as being undesired or uninteresting. If the process determines in step 802, that message identifiers are present, the process selects an unprocessed message identifier (step 804).

Next, the process compares the message identifier to the received e-mail message (step 806). The process determines whether a match is present between the e-mail message and the message identifier (step 808).

If the process determines there is a match in step 808, the e-mail message received is placed in an alternate folder (step 810) with the process terminating thereafter. The alternate folder is any folder other than the inbox. This folder may be defined by the user or set by default. Also, the message may be erased or deleted rather than being placed into a folder, such as a trash bin or spam folder.

Turning back to the determination made in step 808, if a match is not present, the process further determines if more unprocessed identifiers are present (step 812). If there are more unprocessed message identifiers present in step 812, the process returns to step 804 and continues as described above. If no more unprocessed message identifiers are present in step 812, the process places the received e-mail message in the users inbox (step 814), with the process terminating thereafter.

Turning further back into the process, if a determination is made that a set of message identifiers are not present in step 802, the process terminates.

Thus, the illustrative embodiments provide a computer implemented method, apparatus, and computer usable program code for managing e-mail messages. In particular, the illustrative embodiments allow the user to designate a received e-mail message as being undesired or un-interesting. The e-mail message is identified in a manner such that subsequent replies or forwards of the e-mail message to the user are placed in another folder other than the inbox. In these examples, the message identifier is used to identify related messages that belong to the same thread of the selected e-mail message.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing e-mail messages, the computer implemented method comprising:
responsive to a selection of a particular e-mail message from a sender as being undesired, storing an message identifier located in the e-mail message, wherein the message identifier uniquely identifies the e-mail message and any subsequent replies based on the e-mail message; and
responsive to receiving another e-mail message, processing the another e-mail message using a policy to filter out e-mail messages containing the message identifier, wherein subsequent e-mail messages from the sender without the message identifier are unfiltered.

2. The computer implemented method of claim 1, wherein the message identifier is a first message identifier and wherein processing step comprises:
identifying a second message identifier in the another e-mail message;
comparing the first message identifier with the second message identifier; and
responsive to the first message identifier matching the second message identifier placing the another e-mail message in a selected folder.

3. The computer implemented method of claim 1, wherein the e-mail messages containing the message identifier are placed in a location other than an in-box.

4. The computer implemented method of claim 1, wherein the location is a trash bin.

5. The computer implemented method of claim 1, wherein subsequent messages containing the message identifier are replies particular e-mail message that are carbon copied.

6. The computer implemented method of claim 1, wherein the storing step and the processing step are performed by one of an e-mail application on a client computer and an e-mail server.

7. The computer implemented method of claim 6, wherein the e-mail application is a Web browser.

8. A computer program product comprising:
a computer usable medium having computer usable program code for processing e-mail messages, the computer program medium comprising:
computer usable program code for storing a message identifier located in an e-mail message in response to a selection of a particular e-mail message from a sender as being undesired, wherein the message identifier uniquely identifies the e-mail message and any subsequent replies based on the e-mail message; and
computer usable program code for processing the another e-mail message using a policy to filter out e-mail messages containing the message identifier in response to receiving another e-mail message, wherein subsequent e-mail messages from the sender without the message identifier are unfiltered.

9. The computer program product of claim 8, wherein the message identifier is a first message identifier and wherein the computer usable program code, responsive to receiving another e-mail message, processing the another e-mail message using a policy to filter out e-mail messages containing the message identifier, wherein subsequent e-mail messages from the sender without the message identifier are unfiltered comprises:
computer usable program code for identifying a second message identifier in the another e-mail message;
computer usable program code for comparing the first message identifier with the second message identifier; and
computer usable program code for responsive to the first message identifier matching the second message identifier placing the another e-mail message in a selected folder.

10. The computer program product of claim 8, wherein the e-mail messages containing the message identifier are placed in a location other than an inbox.

11. The computer program product of claim 8, wherein the location is a trash bin.

12. The computer program product of claim 8, wherein subsequent messages containing the message identifier are replies particular e-mail message that are carbon copied.

13. The computer program product of claim 8, wherein the computer program product is for one of an e-mail application on a client computer and an e-mail server.

14. The computer program product of claim 13, wherein the e-mail application is a Web browser.

15. A data processing system comprising:
a bus;
a communications unit connected to the bus;
a storage device connected to the bus, wherein the storage device includes computer usable program code; and
a processor unit connected to the bus, wherein the processor unit executes the computer usable program code, responsive to a selection of a particular e-mail message from a sender as being undesired, storing an message identifier located in the e-mail message, wherein the message identifier uniquely identifies the e-mail message and any subsequent replies based on the e-mail message; and responsive to receiving another e-mail message, processing the another e-mail message using a policy to filter out e-mail messages containing the message identifier, wherein subsequent e-mail messages from the sender without the message identifier are unfiltered.

16. The data processing system of claim 15, wherein the message identifier is a first message identifier and wherein in executing the computer usable program code to process the another e-mail message using a policy to filter out e-mail messages containing the message identifier, in response to receiving another e-mail message, wherein subsequent e-mail messages from the sender without the message identifier are unfiltered, the processor unit executes the computer usable program code to identify a second message identifier in the another e-mail message; compare the first message identifier with the second message identifier; and in response to the first message identifier matching the second message identifier placing the another e-mail message in a selected folder.

17. The data processing system of claim 15, wherein the e-mail messages containing the message identifier are placed in a location other than an in-box.

18. The data processing system of claim 15, wherein the location is a trash bin.

19. The data processing system of claim 15, wherein subsequent messages containing the message identifier are replies particular e-mail message that are carbon copied.

20. The data processing system of claim 15, wherein the computer usable program code is for one of an e-mail application on a client computer and an e-mail server.
